(19) United States
(12) Patent Application Publication
(10) Pub. No.: US 2004/0111749 A1
(43) Pub. Date: Jun. 10, 2004

(54) Demanding a video program by using demand short message

(75) Inventors: Jian Zhang, Shanghai (CN); Ling Shao, Beijing (CN); Dong Xie, Beijing (CN)

Correspondence Address: Louis P. Herzberg, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/667,834

(22) Filed: Sep. 22, 2003

(30) Foreign Application Priority Data
Sep. 23, 2002 (CN) 02142879.4

(51) Int. Cl. H04N 7/173

(52) U.S. Cl. 725/87

(57) ABSTRACT

Demanding a video program via a short message. An example method comprises: generating, at a user end, a demand short message, wherein the short message includes a User Identifier field, a Program Identifier field of the demanded video program and an Authentication field; sending to a program delivering end the short message; receiving the short message at the program delivering end; processing the received demand short message to extract the user identifier and authenticating the legality of the user; after authenticating the legality of the user successfully, sending program content corresponding to the program identifier from the program delivering end to the user end indicated by the user identifier; and receiving the demanded video program at the user end. By using a demand short message with an authentication function according to the present invention, a remote Video-on-Demand can be implemented conveniently and safely with low cost and strong security.

### FIELD OF INVENTION

The present invention relates to video on demand (VOD), particularly to a VOD system and a method for demanding a video program by using a demand short message with an authentication function.

### BACKGROUND OF THE INVENTION

In a VOD system, it is necessary to have a return channel for transmitting a user request to a VOD service provider. In a conventional VOD system, a user usually make a demand for video through a return channel like the Internet or a dual-directional cable used in cable TV broadcasting, such as the systems disclosed in U.S. Pat. No. 5,945,987, “Interactive Entertainment Network System and Method for Providing Short Sets of Preview Video Trailers”, U.S. Pat. No. 5,973,722, “Combined Digital Audio/Video on Demand and Broadcast Distribution System”, US patent publication US2002/0019984A1, “Headend Cherrypicker with Digital Video Recording Capability” and etc. However, in the case that it is inconvenient for a user to utilize the Internet, or there is no return channel of a dual-directional cable used in cable TV broadcasting, the user can only makes a demand for video via a telephone. Furthermore, when making a demand for video by using the above-mentioned return channel of the Internet or the dual-directional cable used in cable TV broadcasting, not only the cost and expense are relatively high, but also the use of the user is inconvenient. In the case of demanding a video program by phone, it is difficult to guaranty the security and privacy.

A method for solving the above-mentioned problem is to send a short message to a demand processing apparatus by using an apparatus indirectly connected to the demand processing apparatus of the VOD system, so as to realize the demanding of a video program. The short message can be realized as a remote communication between people with low cost and is convenient for computer processing. Therefore, the short message is widely applied in the current mobile communication system and the social life of people. In addition, using the short message as a return channel further omits such works which are not only troublesome but also expensive as reconstructing a CATV cable into a dual-directional cable, installing an Internet access unit and function for a user's receiving apparatus, etc.

However, the conventional short message application has such an obvious disadvantage as being limited only to exchanging information with a low security requirement. This is because a user identity can only be authenticated by the phone number, and if a family has several mobile phones and each family member can use any one of the mobile phones to send a short message, then the phone number will not be a suitable identifier for the VOD system. In addition, it is also not safe to use a phone number as an identifier, e.g., one can use the phone number of another one to send a short message for demanding a video. Furthermore, the current short messages are all sent in plain text without encryption, so their safety and security are difficult to be guaranteed. As the hacker technology develops continuously, it has been not very difficult to identify the ID of a user's mobile phone and use it. Thus, if VOD is made by using a short message of mobile phone, the security can not be ensured.

### SUMMARY OF INVENTION

Considering the above mentioned situation, an aspect of the present invention is to provide a Video-on-Demand method for demanding a video program by using a demand short message with an authentication function, so as to realize the remote VOD conveniently and safely with low cost and high security.

Another aspect of the present invention is to provide a Video-on-Demand system for demanding a video program by using a demand short message with an authentication function, so as to realize the remote VOD conveniently and safely with low cost and high security.

Yet another aspect of the present invention is to provide a demand short message generating apparatus and method for generating a demand short message with an authentication function.

Still another aspect of the present invention is to provide a demand short message processing apparatus and method for processing a demand short message with an authentication function.

In order to achieve the above-mentioned aspects, the present invention provides a Video-on-Demand method for demanding a video program via a short message, comprising the steps of: generating, at a user end, a demand short message including information on the demanded video program, said demand short message including at least a User Identifier field, a Program Identifier field of the demanded video program and an Authentication field; sending to a program delivering end the generated demand short message; receiving the demand short message at the program delivering end, and processing the received demand short message to extract the user identifier and using the Authentication field to authenticate the legality of the user; after authenticating the legality of the user successfully, sending program content corresponding to the program identifier from the program delivering end to the user end indicated by the user identifier; and receiving the demanded video program at the user end.

According to yet another aspect of the present invention, there is provided a short message generating means in a Video-on-Demand system, comprising: a receiving unit for receiving a user demand; a program information generating unit for generating, according to the user demand, program information including at least a User Identifier field and a Program Identifier field of the demanded video program; an Authentication field generating unit for generating an Authentication field according to the program information generated by the program information generating unit; and an output unit for outputting said program information and the Authentication field as a demand short message to the short message sending means.

### BRIEF DESCRIPTION OF THE DRAWINGS

The present invention can be understood better from the following description in conjunction with the accompanying drawings, where a like reference sign refers to a unit with a same structure, and in which:

FIG. 1 is a block diagram of a VOD system according to a preferred embodiment of the present invention;

FIG. 2 is a detailed block diagram of the short message generating means in FIG. 1 according to a preferred embodiment of the present invention;

FIG. 3 is view showing the format of the demand short message generated by the short message generating means in FIG. 2 according to a preferred embodiment of the present invention;

FIG. 4 is a detailed block diagram of the short message processing means in FIG. 1 according to a preferred embodiment of the present invention; and

FIG. 5 is a flow chart of a VOD method according to a preferred embodiment of the present invention.

### DESCRIPTION OF THE INVENTION

The present invention provides Video-on-Demand methods and apparatus for demanding a video program by using a demand short message with an authentication function, so as to realize the remote VOD conveniently and safely with low cost and high security. The present invention also provides a Video-on-Demand system for demanding a video program by using a demand short message with an authentication function, so as to realize the remote VOD conveniently and safely with low cost and high security. The present invention also provides a demand short message generating apparatus and method for generating a demand short message with an authentication function. It also provides a demand short message processing apparatus and method for processing a demand short message with an authentication function.

In an example embodiment, the present invention provides a Video-on-Demand method for demanding a video program via a short message, comprising the steps of: generating, at a user end, a demand short message including information on the demanded video program, said demand short message including at least a User Identifier field, a Program Identifier field of the demanded video program and an Authentication field; sending to a program delivering end the generated demand short message; receiving the demand short message at the program delivering end, and processing the received demand short message to extract the user identifier and using the Authentication field to authenticate the legality of the user; after authenticating the legality of the user successfully, sending program content corresponding to the program identifier from the program delivering end to the user end indicated by the user identifier; and receiving the demanded video program at the user end.

In the above VOD method according to the present invention, if a video program demanded by a user needs to be encrypted, then an encrypted reply message containing a content key of the video program is generated and sent to the user end, thus the content key can be decrypted from the encrypted reply message at the user end, and the video program received from the program delivering end is decrypted by the content key.

In the present invention, there is provided an embodiment for a Video-on-Demand system for demanding a video program via a short message, comprising: a short message generating means for receiving a user demand, and generating a demand short message based on the user demand, said demand short message including at least a User Identifier field, a Program Identifier field of the demanded video program and an Authentication field; a short message sending means for sending the demand short message generated by the short message generating means; a demand short message processing means at a program delivering end for receiving the demand short message, and processing the received demand short message to extract the user identifier and using the Authentication field to authenticate the legality of the user, and sending the program identifier of the demanded program by a legal user to video delivering means; a video delivering means for sending program content corresponding to the program identifier from the program delivering end to the user end indicated by a legal user identifier; and a program playing means at the user end for receiving the video program sent by the video delivering means and playing it back to the user.

In the above VOD system according to the present invention, if a video program demanded by a user needs to be encrypted, then the demand short message processing means further generates an encrypted reply message containing a content key of the video program and sends it to the user end, the program playing means at the user end can decrypt the content key from the encrypted reply message, and decrypt the video program received from the video delivering means according to the content key.

In another embodiment, the present invention also provides a short message generating means in a Video-on-Demand system, comprising: a receiving unit for receiving a user demand; a program information generating unit for generating, according to the user demand, program information including at least a User Identifier field and a Program Identifier field of the demanded video program; an Authentication field generating unit for generating an Authentication field according to the program information generated by the program information generating unit; and an output unit for outputting said program information and the Authentication field as a demand short message to the short message sending means.

The present invention further provides a short message generating method in a Video-on-Demand system, comprising the steps of: receiving a user demand; generating, according to the user demand, program information including at least a User Identifier field and a Program Identifier field of the demanded video program; generating an Authentication field according to the generated program information; and outputting said program information and the Authentication field as a demand short message to the short message sending means.

According to still another embodiment, there is provided demand short message processing means in a Video-on-Demand system, comprising: a receiving unit for receiving a demand short message; an extracting unit for extracting a user identifier from the demand short message received by the receiving unit; an authentication unit for authenticating the legality of the user identified by the user identifier extracted by the extracting unit, according to the Authentication field in the demand short message received by the receiving unit; and an outputting unit for outputting the program identifier of the program which the legal user demands.

According to a still other embodiment of the present invention, there is provided a demand short message processing method in a Video-on-Demand system, comprising the steps of: receiving a demand short message; extracting a user identifier from the received demand short message; authenticating the legality of the user identified by the extracted user identifier, according to the Authentication field in the received demand short message; and outputting the program identifier of the program which the legal user demands.

Using the VOD system and method, the short message generating means and method, and the demand short message processing means and method, according to the present invention are not only convenient and reliable, but also simple and easy for execution, omitting the dual-directional reconstruction for the system demanding a video through a CATV cable, and making those users without Internet access convenient. Meantime, the security is guaranteed, providing a good operating environment for an operator.

An embodiment of the present invention will be described hereinafter in detail in conjunction with the drawings. In the following description, known units in a conventional VOD system will no longer be described so as to prevent unnecessary details from confusing the present invention.

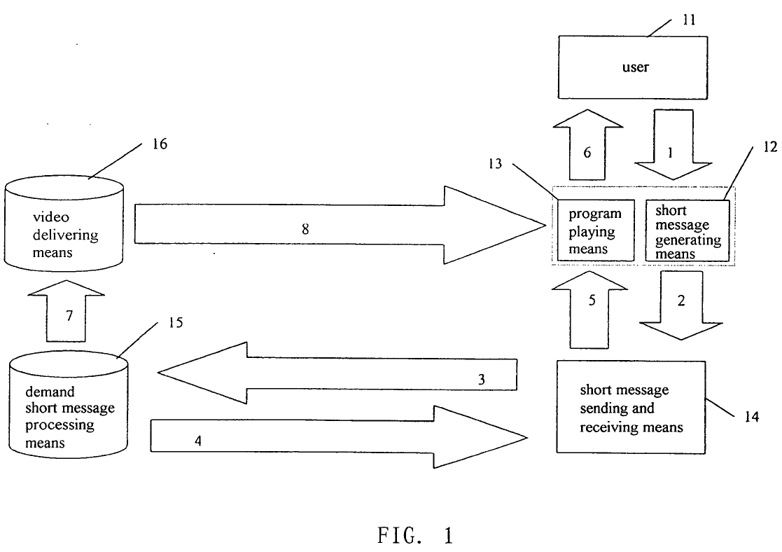

FIG. 1 is a block diagram of a VOD system according to a preferred embodiment of the present invention. As shown in FIG. 1, a VOD system according to a preferred embodiment of the present invention comprises: a short message generating means 12 for receiving a user demand, and generating a demand short message based on the user demand, said demand short message including at least a User Identifier field, a Program Identifier field of the demanded video program and an Authentication field; a short message sending and receiving means 14 for sending the demand short message generated by the short message generating means and for receiving a reply message, sent from a program delivering end and including a confirmation message informing that the demand short message has been received; a demand short message processing means 15 at the program delivering end, which, e.g., makes a request to a processing server for receiving the demand short message, processing the received demand short message to extract the user identifier and using the Authentication field to authenticate the legality of the user, and sending the program identifier of the demanded program by a legal user to the video delivering means 16 such as a VOD server; a video delivering means 16 for sending program content corresponding to the program identifier from the program delivering end to the user end indicated by a legal user identifier; and a program playing means 13 at the user end for receiving the video program sent by the video delivering means 16 and playing it back to the user.

In the system, the short message sending and receiving means 14 for sending the demand short message is generally a mobile phone which are very popular currently, thereby not only making the user who is inconvenient to access using the Internet convenient to request a video service, but also omitting the dual-directional reconstruction for an existing CATV cable, thus contributing to the popularity and development of the VOD service. Of course, in the system, any other means capable of sending a short message can be used as the short message sending and receiving means 14. For example, in some cities a service for sending a short message by fixed phone has been opened, therefore a short message can also be sent by using a fixed phone. In addition, the connection between the short message generating means 12 and the short message sending and receiving means 14 can be either wireless connection or a wired connection.

That the VOD system requires relatively high safety and reliability, and a service provider for supplying a VOD service must be able to authenticate whether a demanding user is a legal user. But the current common short message is sent in plain text which is easy to be imitated, thus the authentication of the security and the user legality can not be achieved by using a conventional short message format. The short message generating means 12 according to the present invention then can generate a short message with an authentication function which is secret and can authenticate the user legality. The short message generating means 12 according to the present invention and its generated encrypted short message format will be described in detail hereinafter.

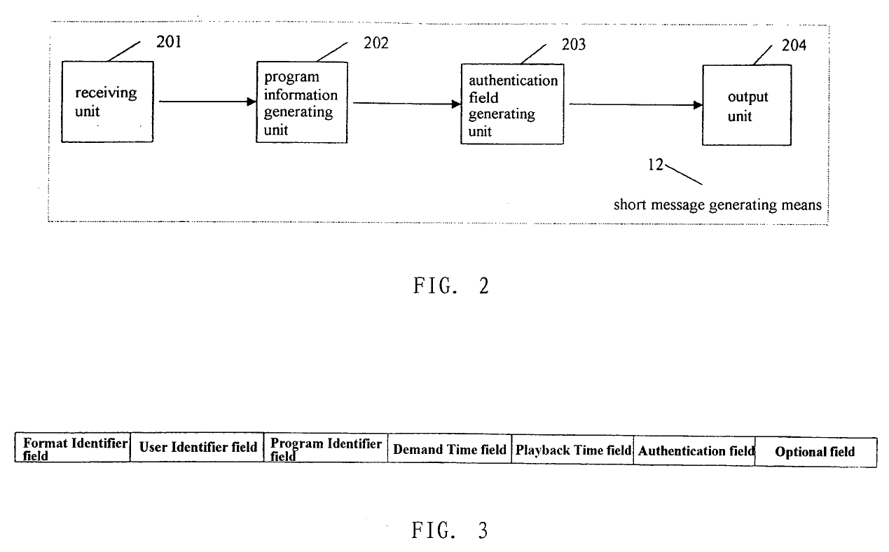

FIG. 2 is a detailed block diagram of short message generating means 12 according to a preferred embodiment of the present invention. As shown in FIG. 2, short message generating means 12 according to a preferred embodiment of the present invention comprises: a receiving unit 201 for receiving a user demand; a program information generating unit 202 for generating related user-demanded program information including a User Identifier field, a Program Identifier field of the demanded video program, a Format Identifier field for defining a format of said demand short message, a Demand Time field for indicating the time for sending said demand, a Playback Time field for indicating the start time of video playing, and etc.; an Authentication field generating unit 203 for using a digest algorithm such as MD5 to compute a digest of the above-mentioned fields, encrypting the computed digest with an encryption algorithm such as 3DES by using a secret authentication key that is uniquely assigned in advance by the video delivering means and that is corresponding to short message generating means 12, so as to generate an Authentication field; and an output unit 204 for outputting said program information and the Authentication field as a demand short message to the short message sending and receiving means 14.

In order to be more secure, the short message generating means 12 can be further provided with an encryption unit (not shown in the drawings) for encrypting all the fields in the generated demand short message except the Authentication field, so as to enable the related user-demanded program information more secure and reliable. At this time, the Authentication field can be a field obtained by computing a digest of other encrypted fields mentioned above and using a secret authentication key to encrypt.

In addition, in order to facilitate sending, receiving and conforming to the current short message, the sum of the lengths of all the fields is preferably not larger than 100 bytes. The demand short message can also include an Optional field not larger than 40 bytes, which contains optional data that may describe the demand more precisely.

An advantegeous format of the demand short message generated by short message generating means 12 of the present invention is shown in FIG. 3. The description of each field is as follows.

A Format Identifier field of 8 bits defines a format of said demand short message;

A User ID field of 32˜64 bits identifies a user and a short message generating means;

A Program ID field of a variable length between 20-72 bytes indicates a video program demanded by a user;

A Demand Time field of 32 bits indicates the time for sending the demand;

A Playback Time field of 32 bits indicates the start time of video playing, such as “RIGHT NOW”;

An Optional field of less than 40 bits contains optional data that may describe said demand more precisely; and

An Authentication field of 128 bits is an encrypted digest of all above message, which can be checked by the demand short message processing means 15, to prove that it is a legal user who sends a demand short message, so as to allow the video delivering means 16 to send a program content only to the legal user end.

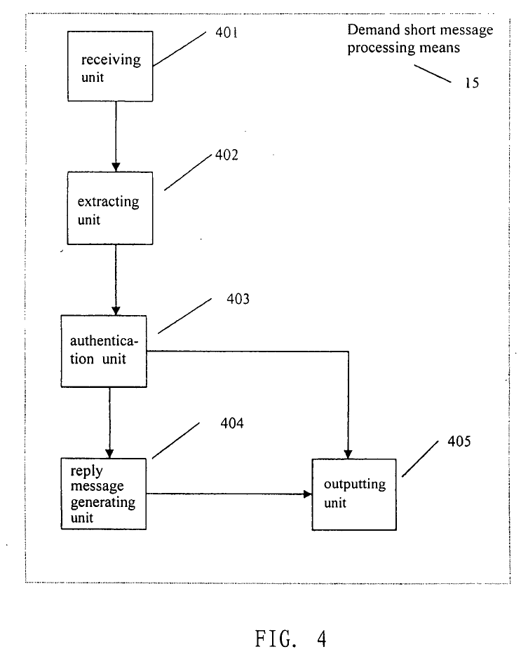

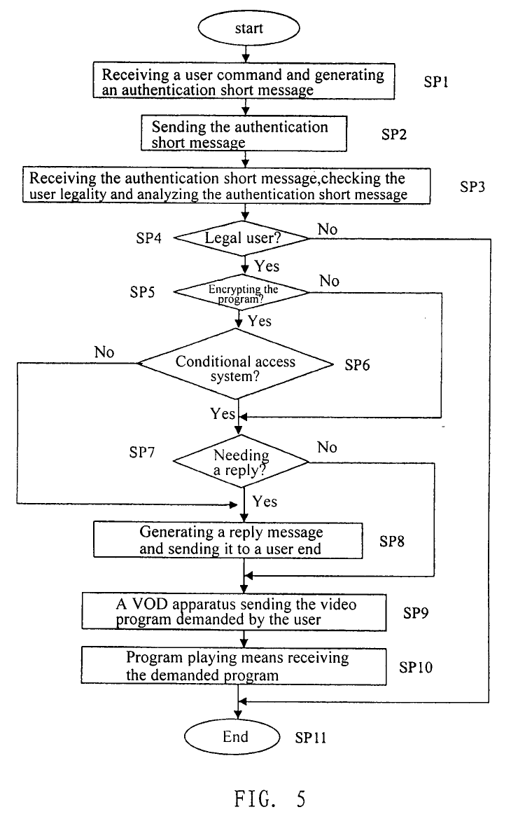

Corresponding to the short message generating means 12, the demand short message with an authentication function, generated by the short message generating means 12 and sent by the short message sending and receiving means 14, must be able to be encrypted in the demand short message processing means 15 at the side supplying a VOD service. FIG. 4 shows a detailed block diagram of the demand short message processing means 15 according to a preferred embodiment of the present invention.

As shown in FIG. 4, the demand short message processing means 15 according to an example embodiment of the present invention comprises: a receiving unit 401 for receiving a demand short message send by short message sending and receiving means 14; an extracting unit 402 for processing the received demand short message and extracting program-related information such a user identifier and etc.; an authentication unit 403 for using a digest algorithm such as MD5 to compute a digest of said User ID field, Program ID field, Format Identifier field, Demand Time field and Playback Time field, extracted by the extracting unit 402, encrypting the computed digest with an encryption algorithm such as 3DES by using a secret authentication key uniquely and correspondingly assigned to the short message generating means 12 at the user end in advance by the video delivering means 16, so as to generate an Authentication field in a demand short message, and checking whether the calculated Authentication field and the received Authentication field are identical; a reply message generating unit 404 for generating a reply message, to be sent to short message sending and receiving means 14, which at least contains a confirmation message indicating the demand short message has been received; and an outputting unit 405 for sending to program playing means 13 the confirmation reply message generated by the reply message generating unit 404 through the short message sending and receiving means 14, or, in the case that a video program is sent by means of a conditional access system, for outputting the reply message to the video delivering means 16 which sends the reply message together with the encrypted video content to the short message generating means 12. Meantime, the outputting unit 405 outputs to the video delivering means 16 the program-related information extracted by the extracting unit, such as the User ID field, Program ID field, Format Identifier field, Demand Time field and Playback Time field, so that video delivering means 16 can provide the demanded video program only to a legal user.

The simplest format of the reply message is obtained by adding a key field containing a content key indicating the encryption on the basis of the above demand short message. The length of the key field is not larger than 128 bits. Wherein, the encrypted content key is encrypted by using a device key corresponding to a unique ID of the short message generating means, exclusively and correspondingly assigned by video delivering means 16. Furthermore, due to well-known encryption knowledge that the more a single key is used the more difficult the guaranty of its security is, it is advantageous that the device key is different from the authentication key, although not necessary.

In addition, the short message generating means 12 at a user end should further include a reply message decrypting unit for decrypting a content key from a received encrypted reply message and decrypting the video program received from the video delivering means 16 according to the decrypted content key. Furthermore, if an encrypting unit for encrypting a demand short message is configured in the short message generating means 12, then a decrypting unit (not shown) for decrypting the encrypted demand short message received from the short message sending and receiving means 14 should be configured in the demand short message processing means 15.

The above-mentioned relates to the VOD system according to a an embodiment according to the present invention. A method for a user to demand a video program in the above-mentioned VOD system will be described hereinafter. A VOD method according to the present invention comprises the steps of: firstly, generating, at a user end, a demand short message including information on the demanded video program, said demand short message including at least a User Identifier field, a Program Identifier field of the demanded video program and an Authentication field; then sending to a program delivering end the generated demand short message; receiving the demand short message at the program delivering end, and processing the received demand short message to extract the user identifier and using the Authentication field to authenticate the legality of the user; next, after authenticating the legality of the user successfully, sending program content corresponding to the program identifier from the program delivering end to the user end indicated by the user identifier; and subsequently, receiving the demanded video program at the user end.

The above-described VOD method used in the above-mentioned VOD system, so as to allow user to conveniently demand a favorite program by using a short message with an authentication function, and not increase additional spending, will be described in detail in conjunction with FIG. 5. FIG. 5 is a flow chart of a VOD method according to a preferred embodiment of the present invention. As shown in FIG. 5, after a user sends a command to demand a program he wants to view, at step SP 1, the short message generating means 12 receives the command and generates a demand short message with an authentication function, containing the video program the user demands for, according to the user's command, the demand short message containing a Format Identifier field for defining a format of said demand short message; a User ID for identifying a user identity, a Program ID field for indicating a video program demanded by a user, a Demand Time field for indicating the time for sending the demand, a Playback Time field for indicating the start time of video playing, an Optional field containing optional data that may describe said demand more precisely, and an Authentication field as an encrypted digest of all above fields.

An Authentication can be generated according to the following procedure. The Authentication field is generated according to the steps of: firstly, calculating a digest of all the above-mentioned fields by using a digest algorithm such as MD5; and then encrypting with a cipher algorithm such as 3DES the calculated digest by adopting a secret authentication key corresponding to short message generating means 12 and uniquely assigned in advance by the video delivering means, so as to generate an Authentication field.

Here, the other fields except the Authentication field can also be encrypted so as to make the demand short message sent by the user more secure and reliable. At this time, the Authentication field can be a field obtained by calculating a digest of all the other fields encrypted above and using a secret authentication key to encrypt.

Next, at step SP2, short message sending and receiving means 14 sends to demand short message processing means 15 at the side supplying a VOD service the demand short message with the authentication function.

Next, at step SP3, demand short message processing means 15 receives the demand short message sent by short message sending and receiving means 14, processes the received demand short message, extracts program-related information such as User ID and etc., and checks whether the user is legal by using the Authentication field.

Whether the user is legal can be checked according to the steps of: firstly, calculating the digest of such extracted fields as the User ID field, Program ID field, Format Identifier field, Demand Time field and Playback Time field by using a digest algorithm such as MD5; then encrypting with a cipher algorithm such as 3DES the calculated digest by adopting a secret authentication key uniquely and correspondingly allocated in advance by video delivering means 16 to short message generating means 12 at a user end, so as to generate an Authentication field; and then checking whether the calculated Authentication field and the received Authentication field are identical.

If the two are identical, then at step SP4, it is determined whether the user sending the demand short message is a legal one. If the two is not identical, then it indicates the user is an illegal one and the process proceeds to step SP11 where demand short message processing means 15 records the illegal user and ends the process.

If at step SP94 it is determined that the user sending the demand short message is a legal one, then the process proceeds to step SP5 to determine whether the program demanded by the user needs to be encrypted.

If at step SP5 it is determined that the program demanded by the user needs to be encrypted, then the process proceeds to step SP6. At step SP6, it is determined that whether the program demanded by the user is sent by means of a conditional access system. If not, then at step SP8 a reply message containing at least an encryption key for encrypting the program content must be generated, sent to short message sending and receiving means 14 at the user end, and then provided to program playing means 13, so as to decrypt the received encrypted program content with the encryption key when playing back the program.

If at step SP5 it is determined that the program demanded by the user needs not be encrypted and at step SP6 it is determined that the program demanded by the user is sent by means of a conditional access system, then the process proceeds to step SP7 to determine whether it is necessary to send a reply message to the user end.

That is to say, at this time, if the program demanded by the user needs not be encrypted, then an encryption key needs not be sent; and although the program demanded by the user is encrypted, since the encrypted content is sent by means of a conditional access system, it is unnecessary for demand short message processing means 15 to send an encryption key to the user end, which can be directly sent to program playing means 13 through a special channel of the conditional access system.

If at step SP7 it is determined that a piece of confirmation information, i.e. the confirmation information indicating the user's demand has been received, should be sent to the user end, then at step SP8 the confirmation information is generated and sent to short message sending and receiving means 14, informing the user the demand has been received.

Next at step SP9, demand short message processing means 15 provides the extracted information related to the program demanded by the user to video delivering means 16, and video delivering means 16, according to the program information, sends the program content corresponding to the program ID to the user end indicated by the user ID at a suitable time. Meantime, program playing means 13 at the user end receives the program sent from video delivering means.

While embodiments have been described above in conjunction with drawings, the present invention is not limited to these embodiments and various changes may be made without departing from the spirit and scope of the invention as defined by the appended claims. For example, short message generating means 12 and program playing means 13 can be integrated into one unit and configured in a conventional set-top box. In addition, the method shown in the above-mentioned flow chart of FIG. 5 does not necessarily need to be executed according to the described sequence strictly and some steps can be skipped. For example, the demand short message may not be encrypted, and, of course, the demand short message processing means at the side supplying the VOD service needs not decrypt the received demand short message. In addition, the VOD method according to the present invention can be realized by using a computer program and recorded in a computer-readable recording media, and the whole system can be realized with the aid of a general purpose PC. With the VOD system and method of the present invention, it is no longer necessary to conduct a dual-directional reconstruction to an existing system demanding a video program through a CATV cable, making those users without Internet access convenient. Meantime, the security is guaranteed, providing an operator with a good operating environment.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

We claim:

1. A Video-on-Demand method for demanding a video program via a short message, comprising the steps of:
generating, at a user end, a demand short message including information on the demanded video program, said demand short message including at least a User Identifier field, a Program Identifier field of the demanded video program and an Authentication field;
sending to a program delivering end the generated demand short message;
receiving the demand short message at the program delivering end, and processing the received demand short message to extract a user identifier and using the Authentication field to authenticate legality of the user;
after authenticating the legality of the user successfully, sending program content corresponding to a program identifier from the program delivering end to the user end indicated by the user identifier; and
receiving the demanded video program at the user end.

2. A Video-on-Demand method according to claim 1, further comprising the step of sending from the program delivering end to the user end a reply message including a confirmation message indicating that the demand short message has been received.

3. A Video-on-Demand method according to claim 1, further comprising the steps of:
encrypting the fields in the generated demand short message except the Authentication field at the user end, and
decrypting the received encrypted short message at the program delivering end to extract the user identifier and the program identifier.

4. A Video-on-Demand method according to claim 1, wherein said demand short message further comprising:
a Format Identifier field for defining a format of said demand short message;
a Demand Time field for indicating a time for sending said demand;
a Playback Time field for indicating a start time of video playing;
an Optional field containing optional data that may describe said demand more precisely; and
said Authentication field is an encrypted digest of the above User Identifier field, Program Identifier field, Format Identifier field, Demand Time field, Playback Time field, and Optional field.

5. A Video-on-Demand method according to claim 4, wherein said Authentication field is generated according to the following procedure:
calculating the digest of all the fields except the Authentication field using a digest algorithm;
encrypting with a cipher algorithm a calculated digest by adopting a secret authentication key corresponding to a user end device, uniquely allocated in advance by the program delivering end; and
a process of authenticating a user's legality by the program delivering end being conducted according to the following procedures:
calculating the digest of all the fields except the Authentication field using a digest algorithm;
encrypting with a cipher algorithm the calculated digest by adopting a secret authentication key corresponding to a user end device, uniquely allocated in advance by the program delivering end, so as to calculate an Authentication field; and
checking whether the calculated Authentication field and the received Authentication field are identical.

6. A Video-on-Demand method according to claim 5, wherein when said video program is sent via a conditional access system, a content key is delivered with the video program, so there is no need for a separate deliver of said reply message.

7. A Video-on-Demand method according to claim 5, wherein when the video program demanded by the user needs to be encrypted and the encrypt key is not sent via a conditional access system, the method further comprising the steps of:
generating, at the program delivering end, an encrypted reply message containing a content key of said video program, and sending it to the user end;
decrypting, at the user end, the content key from said encrypted reply message; and
decrypting the video program received from the program delivering end according to the decrypted content key.

8. A Video-on-Demand method according to claim 7, wherein said encrypted content key is encrypted using a device key corresponding to the user end device, uniquely allocated in advance by the program delivering end, and said device key can be different from said Authentication key.

9. A Video-on-Demand system for demanding a video program via a short message, comprising:
short message generating means for receiving a user demand, and generating a demand short message based on the user demand, said demand short message including at least a User Identifier field, a Program Identifier field of the demanded video program and an Authentication field;
short message sending means for sending the demand short message generated by the short message generating means;
demand short message processing means at a program delivering end for receiving the demand short message, processing the received demand short message to extract the user identifier and using the Authentication field to authenticate the legality of the user, and sending the program identifier of the demanded program by a legal user to video delivering means;
video delivering means for sending program content corresponding to the program identifier from the program delivering end to the user end indicated by a legal user identifier; and
program playing means at the user end for receiving the video program sent by the video delivering means and playing it back to the user.

10. A Video-on-Demand system according to claim 9, wherein the demand short message processing means further comprises a reply message generating unit for generating a reply message including at least a confirmation message indicating that the demand short message has been received, for sending to the user end.

11. A Video-on-Demand system according to claim 9, wherein:
the short message generating means further comprises an encrypting unit for encrypting the fields in the generated demand short message except the Authentication field; and
the demand short message processing means further comprises decrypting means for decrypting the received encrypted short message.

12. A Video-on-Demand system according to claim 9, wherein said short message generating means further comprises a program information generating unit for generating said User Identifier field, said Program Identifier field of the video program demanded by the user and
a Format Identifier field for defining a format of said demand short message,
a Demand Time field for indicating a time for sending said demand,
a Playback Time field for indicating a start time of video playing, and
an Optional field containing optional data that may describe said demand more precisely.

13. A Video-on-Demand system according to claim 12, wherein
said short message generating means further comprises an Authentication field generating unit for calculating a digest of all the fields except the Authentication field using a digest algorithm and encrypting with a cipher algorithm the calculated digest by adopting a secret authentication key corresponding to a user end device, uniquely allocated in advance by the video delivering means; and
said demand short message processing means further comprises an authentication unit for calculating the digest of said User Identifier field, Program Identifier field, Format Identifier field, Demand Time field, Playback Time field and Optional field, encrypting with a cipher algorithm the calculated digest by adopting a secret authentication key corresponding to a user end device, uniquely allocated in advance by the video delivering means, so as to calculate an Authentication field and checking whether the calculated Authentication field and the received Authentication field are identical.

14. A Video-on-Demand system according to claim 13, wherein if said video program is sent via a conditional access system, a content key is delivered with the video program.

15. A Video-on-Demand system according to claim 13, wherein if the video program demanded by the user needs to be encrypted and the encrypt key is not sent via a conditional access system, then
the demand short message processing means generates an encrypted reply message containing a content key of said video program, and sends it to the user end; and
the program playing means at the user end decrypts the content key from said encrypted reply message, and decrypts the video program received from the program playing means according to the decrypted content key.

16. A Video-on-Demand system according to claim 15, wherein said encrypted content key is encrypted using a device key corresponding to the user end device, uniquely allocated in advance by the program delivering end, and said device key can be different from said Authentication key.

17. Short message generating means in a Video-on-Demand system, comprising:
a receiving unit for receiving a user demand;
a program information generating unit for generating, according to the user demand, program information including at least a User Identifier field and a Program Identifier field of the demanded video program;
an Authentication field generating unit for generating a Authentication field according to the program information generated by the program information generating unit; and
an output unit for outputting said program information and the Authentication field as a demand short message to short message sending means.

18. A short message generating means according to claim 17, further comprising:
an encrypting unit for encrypting the fields except the Authentication field in the demand short message.

19. A short message generating means according to claim 17, wherein said program information generating unit further generating:
a Format Identifier field for defining a format of said demand short message,
a Demand Time field for indicating the time for sending said demand,
a Playback Time field for indicating the start time of video playing, and
an Optional field containing optional data that may describe said demand more precisely.

20. A short message generating means according to claim 19, wherein
said Authentication field generating unit calculates the digest of all the fields except the Authentication field using a digest algorithm and encrypts with a cipher algorithm the calculated digest by adopting a secret authentication key determined in advance and uniquely corresponding to said short message generating apparatus.

21. A short message generating means according to claim 20, wherein said digest algorithm is MD5 algorithm, and said cipher algorithm is 3DES algorithm.

22. A short message generating method in a Video-on-Demand system, comprising the steps of:
receiving a user demand;
generating, according to the user demand, program information including at least a User Identifier field and a Program Identifier field of a demanded video program;
generating an Authentication field according to the generated program information; and
outputting said program information and the Authentication field as a demand short message to short message sending means.

23. Demand short message processing means in a Video-on-Demand system, comprising:
a receiving unit for receiving a demand short message;
an extracting unit for extracting a user identifier from the demand short message received by the receiving unit;
an authentication unit for authenticating legality of a user identified by the user identifier extracted by the extracting unit, according to the Authentication field in the demand short message received by the receiving unit; and
an outputting unit for outputting a program identifier of the program which the legal user demands.

24. A demand short message processing method in a Video-on-Demand system, comprising the steps of:
receiving a demand short message;
extracting a user identifier from the received demand short message;
authenticating legality of a user identified by the extracted user identifier, according to the Authentication field in the received demand short message; and
outputting a program identifier of the program which the legal user demands.

25. An article of manufacture comprising a computer usable medium having computer readable program code means embodied therein for causing Video-on-Demand, the computer readable program code means in said article of manufacture comprising computer readable program code means for causing a computer to effect the steps of claim 1.

26. A program storage device readable by machine, tangibly embodying a program of instructions executable by the machine to perform method steps for Video-on-Demand, said method steps comprising the steps of claim 1.

27. A computer program product comprising a computer usable medium having computer readable program code means embodied therein for causing Video-on-Demand, the computer readable program code means in said computer program product comprising computer readable program code means for causing a computer to effect the functions of claim 9.

28. A computer program product comprising a computer usable medium having computer readable program code means embodied therein for causing short message generation, the computer readable program code means in said computer program product comprising computer readable program code means for causing a computer to effect the functions of claim 17.

29. An article of manufacture comprising a computer usable medium having computer readable program code means embodied therein for causing short message generation, the computer readable program code means in said article of manufacture comprising computer readable program code means for causing a computer to effect the steps of claim 22.

30. A program storage device readable by machine, tangibly embodying a program of instructions executable by the machine to perform method steps for short message generation, said method steps comprising the steps of claim 22.

31. A computer program product comprising a computer usable medium having computer readable program code means embodied therein for causing short message generation, the computer readable program code means in said computer program product comprising computer readable program code means for causing a computer to effect the functions of claim 23.

32. An article of manufacture comprising a computer usable medium having computer readable program code means embodied therein for causing demand short message processing, the computer readable program code means in said article of manufacture comprising computer readable program code means for causing a computer to effect the steps of claim 24.

33. A program storage device readable by machine, tangibly embodying a program of instructions executable by the machine to perform method steps for demand short message processing, said method steps comprising the steps of claim 24.
